(19) United States
(12) Patent Application Publication
(10) Pub. No.: US 2023/0288247 A1
(43) Pub. Date: Sep. 14, 2023

(54) SOUND MEASUREMENT METHOD

(71) Applicant: NIPPON TELEGRAPH AND TELEPHONE CORPORATION, Tokyo (JP)

(72) Inventors: Kenji ISHIKAWA, Tokyo (JP); Yoshifumi SHIRAKI, Tokyo (JP); Takehiro MORIYA, Tokyo (JP); Kenichi HITACHI, Tokyo (JP); Atsushi ISHIZAWA, Tokyo (JP); Katsuya OGURI, Tokyo (JP)

(73) Assignee: NIPPON TELEGRAPH AND TELEPHONE CORPORATION, Tokyo (JP)

(21) Appl. No.: 18/017,025

(22) PCT Filed: Jul. 28, 2020
(86) PCT No.: PCT/JP2020/028872

§ 371 Date: Jan. 19, 2023

(51) Int. Cl. G01H 9/00; G01B 9/02001; H04R 23/00

(52) U.S. Cl. CPC G01H 9/00; G01B 9/0201; H04R 23/008

(57) ABSTRACT

An optical phase modulation amount measurement technology using sound without being affected by noise included in an average light intensity is provided. A sound measurement method includes an interference light generation step of obtaining first light including light subjected to light phase modulation by a sound measurement unit and second light including light subjected to light phase modulation by the sound measurement unit, which differs from the first light, from light emitted from a light source, a first light detection step of obtaining a first electrical signal from the first light, a second light detection step of obtaining a second electrical signal from the second light, and a differential signal generation step of obtaining a differential signal that is a difference between the first electrical signal and the second electrical signal, wherein a phase of the light subjected to light phase modulation included in the first light and a phase of the light subjected to the light phase modulation included in the second light are in an inverted relationship, and an optical phase modulation amount φₛ by sound is measured as a current Δi of the differential signal expressed by an equation Δi=βI_{A} cos (φₛ+φ₀) (where β is a predetermined constant, I_{A} is an amplitude of an interference fringe, and φ₀ is an optical phase modulation amount by an element other than sound).

### TECHNICAL FIELD

The present invention relates to a sound measurement technology using light.

### BACKGROUND ART

As one of sound measurement methods using light, there is a method of using a change in refractive index of a medium due to sound called an acousto-optic effect. According to the acousto-optic effect, an optical phase modulation amount φₛ by sound in the air is expressed by the following equation.

$$[ Math . 1 ]$$

$${ϕ}_{s} = k \frac{{n}_{0} - 1}{γ {p}_{0}} \int pdl \qquad ( 1 )$$

Here, k is a wave number of light, n₀ is an air refractive index in a steady state, p₀ is atmospheric pressure in the steady state, γ is a specific heat ratio of air, and p is a sound pressure. Further, an integral of Equation (1) is a linear integral along a propagation path of light.

That is, it is possible to measure sound in a non-contact manner by observing the optical phase modulation amount φₛ by sound given by Equation (1).

Many sound measurement methods using the acousto-optic effect use an optical interferometer. As the optical interferometer, any optical interferometer such as a Michelson type, a Mach-Zehnder type, and a Fizeau type can be used. FIG. 1 illustrates a sound measurement apparatus using a Michelson interferometer. The sound measurement apparatus illustrated in FIG. 1 includes a Michelson interferometer, a sound measurement unit, and a photodetector. The Michelson interferometer also includes the beam splitter and two mirrors. The sound measurement unit is a constituent unit that modulates a phase of light using sound. A laser can be used as a light source. BS, M, and PD in FIG. 1 represent the beam splitter, a mirror, and a photodetector, respectively. An arrow indicates a state in which light is branched and propagated.

Hereinafter, an operation of the sound measurement apparatus in FIG. 1 will be described. The light emitted from the light source is divided into two light beams by the beam splitter. The two light beams propagate through different paths in the interferometer, and at least one light beam passes through the sound measurement unit. Thereafter, the two light beams are multiplexed by the beam splitter. A phase difference between the two light beams is extracted as an electrical signal by detecting the multiplexed light, that is, interference light, using the photodetector. Here, a current i of an electrical signal (output signal) of the photodetector that is an output of the photodetector is expressed by the following equation.

[Math. 2]

i=ηI=η[I_{DC}+I_{A} cos(ϕₛ+ϕ₀)] (2)

Here, η is quantum efficiency of the photodetector, I is an amount of interference light, I_{DC} is a DC component (average light intensity) of the amount of interference light, I_{A} is an amplitude of an interference fringe, and φ₀ is optical phase modulation amount by an element other than sound.

As can be seen from Equation (2), a current i of the output signal varies depending on the phase modulation amount φₛ of the light by sound. Non-contact sound measurement is realized by using this (see NPL 1).

### CITATION LIST

### Non Patent Literature

[NPL 1]: P. Yuldashev, M. Karzova, V. Khokhlova, S. Ollivier, and P. Blanc-Benon, “Mach-Zehnder interferometry method for acoustic shock wave measurements in air and broadband calibration of microphones,” The Journal of the Acoustical Society of America, 137(6), pp. 3314-3324, 2015.

### SUMMARY OF INVENTION

### Technical Problem

A current i of an output signal of the sound measurement apparatus in FIG. 1 is obtained from a result of adding an intensity I_{A} cos (φₛ+φ₀) indicating an influence of interference including an optical phase modulation amount φₛ by sound to an average light intensity I_{DC}. In general, the optical phase modulation amount φₛ by sound is very small, and is very small with respect to the average light intensity I_{DC}. Further, the average light intensity I_{DC} includes noise caused by intensity variation of the light source or the like. This noise cannot be ignored for the optical phase modulation amount φₛ by sound even when the noise is very small with respect to the average light intensity I_{DC}. Therefore, a minimum optical phase modulation amount that can be detected by the sound measurement apparatus is often determined. Therefore, in order to reduce noise in the sound measurement apparatus and to improve an SN ratio, reduction of noise included in the average light intensity I_{DC} is an important issue.

Therefore, an object of the present invention is to provide an optical phase modulation amount measurement technology using sound without being affected by noise included in an average light intensity.

### Solution to Problem

An aspect of the present invention is a sound measurement method for measuring an optical phase modulation amount Ys by sound by a sound measurement apparatus including an interference light generator including an interferometer and a sound measurement unit configured to modulate a phase of light using sound, two photodetectors (hereinafter referred to as a first photodetector and a second photodetector), and a differential signal generator, the sound measurement method including: an interference light generation step of obtaining, by the interference light generator, from light emitted from a light source, light (hereinafter referred to as first light) including light subjected to light phase modulation by the sound measurement unit and light (hereinafter referred to as second light) including light subjected to light phase modulation by the sound measurement unit, the second light differing from the first light; a first light detection step of obtaining, by the first photodetector, an electrical signal (hereinafter referred to as a first electrical signal) from the first light; a second light detection step of obtaining, by the second photodetector, an electrical signal (hereinafter referred to as a second electrical signal) from the second light; and a differential signal generation step of obtaining, by the differential signal generator, a differential signal from the first electrical signal and the second electrical signal, the differential signal being a difference between the first electrical signal and the second electrical signal, wherein a phase of the light subjected to the light phase modulation included in the first light and a phase of the light subjected to the light phase modulation included in the second light are in an inverted relationship, and the optical phase modulation amount φₛ is measured as a current Δi of the differential signal expressed by an equation Δβi=βI_{A} cos (φₛ+φ₀) (where β is a predetermined constant, I_{A} is an amplitude of an interference fringe, and φ₀ is an optical phase modulation amount by an element other than sound).

An aspect of the present invention is a sound measurement method for measuring an optical phase modulation amount φₛ by sound by a sound measurement apparatus including a beam splitter, an interference light generator including an interferometer and a sound measurement unit configured to modulate a phase of light using sound, two photodetectors (hereinafter referred to as a first photodetector and a second photodetector), and a differential signal generator, the sound measurement method including: a light branching step of obtaining, by the beam splitter, two light beams (hereinafter referred to as first light and second light) from light emitted from a light source; an interference light generation step of obtaining, by the interference light generator, light including light subjected to light phase modulation by the sound measurement unit (hereinafter referred to as third light) from the first light; a first light detection step of obtaining, by the first photodetector, an electrical signal (hereinafter referred to as a first electrical signal) from the third light; a second light detection step of obtaining, by the second photodetector, an electrical signal (hereinafter referred to as a second electrical signal) from the second light; and a differential signal generation step of obtaining, by the differential signal generator, a differential signal from the first electrical signal and the second electrical signal, the differential signal being a difference between the first electrical signal and the second electrical signal, wherein the optical phase modulation amount φₛ is measured as a current Δi of the differential signal expressed by an equation Δi=βI_{A} cos (φₛ+φ₀) (where β is a predetermined constant, I_{A}is an amplitude of an interference fringe, and φ₀ is an optical phase modulation amount by an element other than sound).

An aspect of the present invention is a sound measurement method for measuring an optical phase modulation amount φₛ by sound by a sound measurement apparatus including an interference light generator including an interferometer and a sound measurement unit configured to modulate a phase of light using sound, two photodetectors (hereinafter referred to as a first photodetector and a second photodetector), a differential signal generator, and an optical phase modulation amount adjuster, the sound measurement method including: an interference light generation step of obtaining, by the interference light generator, from light emitted from a light source, light (hereinafter referred to as first light) including light subjected to light phase modulation by the sound measurement unit and light (hereinafter referred to as second light) including light subjected to light phase modulation by the sound measurement unit, the second light differing from the first light; a first light detection step of obtaining, by the first photodetector, an electrical signal (hereinafter referred to as a first electrical signal) from the first light; a second light detection step of obtaining, by the second photodetector, an electrical signal (hereinafter referred to as a second electrical signal) from the second light; a differential signal generation step of obtaining, by the differential signal generator, a differential signal from the first electrical signal and the second electrical signal, the differential signal being a difference between the first electrical signal and the second electrical signal; and an optical phase modulation amount adjustment step of adjusting, by the optical phase modulation amount adjuster, an optical phase modulation amount φ₀ by an element other than sound by fixing the interferometer so that a phase of an interference fringe is in mid-fringe by using the differential signal as an error signal, wherein a phase of the light subjected to the light phase modulation included in the first light and a phase of the light subjected to the light phase modulation included in the second light are in an inverted relationship, and the optical phase modulation amount φₛ by sound is measured as a current Δi of the differential signal expressed by an equation Δi=βI_{A} sin (φₛ) (where β is a predetermined constant, and I_{A} is an amplitude of an interference fringe).

### Advantageous Effects of Invention

According to the present invention, it is possible to measure an optical phase modulation amount by sound without being affected by noise included in an average light intensity.

### BRIEF DESCRIPTION OF DRAWINGS

FIG. 1 is a diagram illustrating an example of a configuration of a sound measurement apparatus of the related art.

FIG. 2 is a diagram illustrating an example of a configuration of a sound measurement apparatus of the present application.

FIG. 3 is a diagram illustrating a state of incident light and emitted light in a beam splitter.

FIG. 4 is a diagram illustrating an example of a configuration including a light amount adjuster.

FIG. 5 is a diagram illustrating an example of a configuration of a sound measurement apparatus of the present application.

FIG. 6 is a diagram illustrating an example of a configuration of the sound measurement apparatus of the present application.

FIG. 7 is a diagram illustrating an example of a configuration using a Wollaston prism.

FIG. 8 is a diagram illustrating an example of a configuration of the sound measurement apparatus of the present application.

FIG. 9 is a diagram illustrating an example of a configuration of an optical phase modulation amount adjuster.

FIG. 10 is a diagram illustrating a relationship between a phase of an interference fringe and an intensity of interference light.

FIG. 11 is a diagram illustrating a state of a power spectral density of interference light.

FIG. 12 is a diagram illustrating an example of a configuration using a multipath mirror.

FIG. 13 is a block diagram illustrating a configuration of a sound measurement apparatus 100.

FIG. 14 is a flowchart illustrating an operation of the sound measurement apparatus 100.

FIG. 15 is a block diagram illustrating a configuration of an interference light generator 110.

FIG. 16 is a block diagram illustrating a configuration of the interference light generator 110.

FIG. 17 is a block diagram illustrating a configuration of the interference light generator 110.

FIG. 18 is a block diagram illustrating a configuration of a sound measurement apparatus 200.

FIG. 19 is a flowchart illustrating an operation of the sound measurement apparatus 200.

FIG. 20 is a block diagram illustrating a configuration of a sound measurement apparatus 300.

FIG. 21 is a flowchart illustrating an operation of the sound measurement apparatus 300.

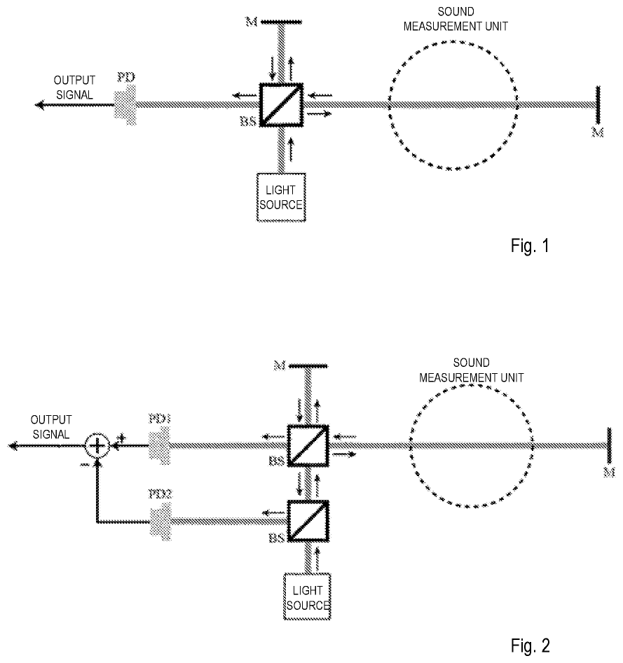

### DESCRIPTION OF EMBODIMENTS

Hereinafter, embodiments of the present invention will be described in detail. Constituent units having the same function are denoted with the same reference signs, and repeated descriptions thereof are omitted.

A notation method in the present specification will be described prior to description of the embodiments.

\hat{ } (caret) indicates a superscript. For example, x^{y\hat{ }z} indicates that y^{z} is a superscript with respect to x and x_{y\hat{ }z} indicates that y^{z} is a subscript with respect to x. Further, _ (underscore) indicates a subscript. For example, x^{y_z} indicates that y^{z} is a superscript with respect to x and x_{y_z} indicates that y_{z} is a subscript with respect to x.

Diacritics “\hat{ }” and “˜” as in ^{\hat{ }}x and ˜x for a certain character x should be written directly above “x,” but the diacritics are written as ^{\hat{ }}X and ˜x due to restrictions on description notation in the specification.

### TECHNICAL BACKGROUND

In an embodiment of the present invention, interference light is differentially detected in sound measurement by light using an acousto-optic effect. This makes it possible to cancel the average light intensity, and remove noise included in the average light intensity. Therefore, it is possible to greatly improve an SN ratio by removing light intensity noise of the light source that is the main noise in a sound measurement apparatus of the related art. Further, it is possible to greatly reduce requirements for intensity stability of the light source when the same degree of SN ratio is to be realized, and to reduce a cost.

Hereinafter, several examples of a configuration of the sound measurement apparatus according to an embodiment of the present invention will be described.

### Configuration Example 1

FIG. 2 is a diagram illustrating a configuration example of the sound measurement apparatus. The sound measurement apparatus illustrated in FIG. 2 is a configuration example of a Michelson interferometer, and includes a beam splitter, an interferometer, a sound measurement unit, two photodetectors, and a differential detection unit. Further, the interferometer includes the beam splitter and two mirrors. In FIG. 2, BS, M, and PD represent the beam splitter, the mirror, and the photodetector, respectively. A cross symbol in o represents the differential detection unit. Further, an arrow indicates a state in which light is branched and propagated.

A laser can be used as the light source. Further, as the interferometer, any interferometer such as a Mach-Zehnder type or a Fizeau type can be used instead of the Michelson interferometer.

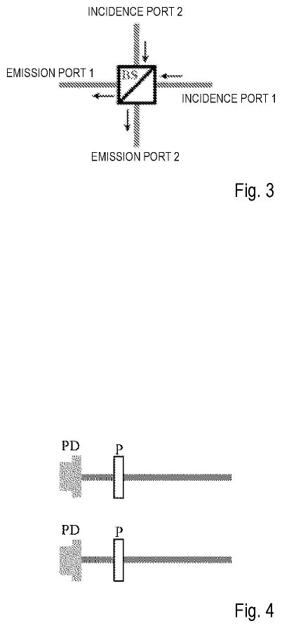

Hereinafter, an operation of the sound measurement apparatus in FIG. 2 will be described. Light emitted from the light source is divided into two light beams by the beam splitter of the interferometer. At least one of the light beams passes through the sound measurement unit one or more times. The two light beams are each reflected by mirrors, incident on the beam splitter of the interferometer, and coupled. Light beams emitted from two emission ports (an emission port 1 and an emission port 2 in FIG. 3) of the beam splitter are detected by photodetectors and converted into electrical signals. A differential signal which is a difference between the two electrical signals is obtained as an output signal.

Here, as illustrated in FIG. 3, a relationship between incident light and emitted light in the beam splitter of the interferometer is considered. The light emitted to the emission port 1 is a sum of a component transmitted through the beam splitter of the light incident from the incidence port 1 and a component reflected by the beam splitter of the light incident from the incidence port 2. The light emitted to the emission port 2 is a sum of a component reflected by the beam splitter of the light incident from the incidence port 1 and a component transmitted through the beam splitter of the light incident from the incidence port 2. In accordance with a law of reflection of light between media having different refractive indices, either one of the component reflected by the beam splitter of the light incident from the incidence port 1 and the component reflected by the beam splitter of the light incident from the incidence port 2 is inverted in phase at the time of reflection. However, the component whose phase is inverted depends on a structure or direction of the beam splitter. Here, it is assumed that a phase of the component reflected by the beam splitter of the light incident from the incidence port 1 is inverted. Here, when E_{IN1} is light incident from the incidence port 1 and E_{IN2} is light incident from the incidence port 2, light E₁ emitted to the emission port 1 and light E₂ emitted to the emission port 2 can be expressed by the following equations.

$$[ Math . 3 ]$$

$${E}_{1} = \frac{1}{\sqrt{2}} ( {E}_{IN 1} + {E}_{IN 2} ) \qquad ( 3 )$$

$$[ Math . 4 ]$$

$${E}_{2} = \frac{1}{\sqrt{2}} ( - {E}_{IN 1} + {E}_{IN 2} ) \qquad ( 4 )$$

When I₁ is an intensity (light amount) of light E_{IN1} and I₂ is an intensity (light amount) of light E_{IN2}, currents i₁ and i₂ of electrical signals output from the two photodetectors PD1 and PD2 can be expressed by the following equations, respectively.

[Math. 5]

i₁=ηI₁=η[I_{DC}+I_{A} cos(ϕₛ+φ₀)] (5)

[Math. 6]

i₂=ηI₂=η[I_{DC}−I_{A} cos(ϕₛ+ϕ₀)] (6)

Therefore, the current Δi of the differential signal, which is an output signal of the differential detection unit, is expressed by the following equation.

[Math. 7]

Δi=η(I₁−I₂)=2ηI_{A} cos(ϕₛ+ϕ₀) (7)

As can be seen from Equation (7), the current Δi of the differential signal does not include a term including the average light intensity I_{DC}. Therefore, it is possible to measure a low-noise sound without being affected by noise caused by, for example, variation of intensity of a light source included in the average light intensity, that is, an optical phase modulation amount φₛ by sound.

As illustrated in FIG. 4, the sound measurement apparatus may include a light amount adjuster (P in FIG. 4) for independently adjusting an amount of light incident on the two photodetectors. Here, a linear polarizer can be used as the light amount adjuster. In the configuration example 1, polarization states of the two light beams are equal. For example, when the two light beams are linearly polarized light beams, it is possible to adjust the amount of light incident on the photodetector by rotating the linear polarizer. Thus, the sound measurement apparatus illustrated in FIG. 2 includes the light amount adjuster, making it possible to solve a problem that the electrical signals output from the two photodetectors do not have completely the same amplitude due to the difference in an incident light amount due to an optical system and a mismatch in sensitivity of the photodetectors.

### Configuration Example 2

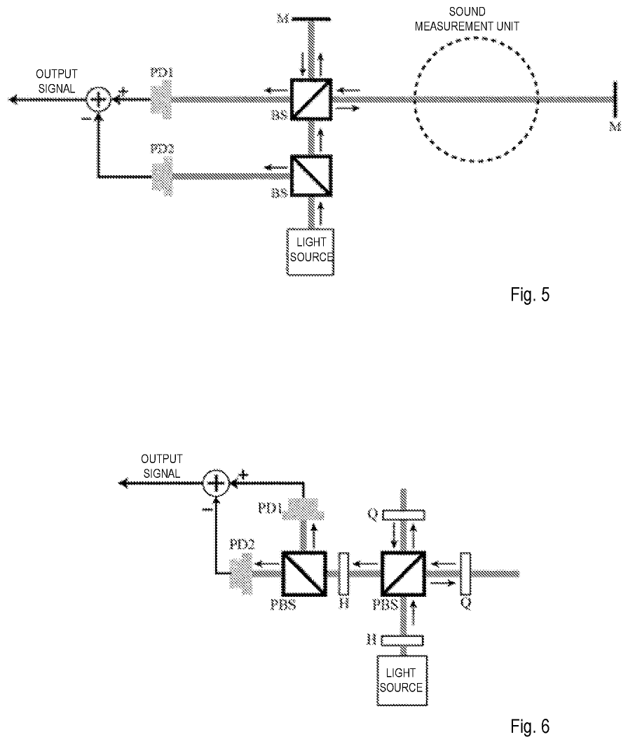

FIG. 5 is a diagram illustrating a configuration example of the sound measurement apparatus. The sound measurement apparatus illustrated in FIG. 5 is an example of the configuration by the Michelson interferometer, similar to the configuration example 1, and includes a beam splitter, an interferometer, a sound measurement unit, two photodetectors, and a differential detection unit. However, a direction of the beam splitter located near the light source is reversed in FIGS. 2 and 5. Therefore, the light detected by the photodetector PD2 does not pass through the interferometer, and an amount of light detected by the photodetector PD2 is only a DC component.

Currents i₁ and i₂ of electrical signals output from the two photodetectors PD1 and PD2 can be expressed by the following equations, respectively.

[Math. 8]

i₁=ηI₁=η[I_{DC}+I_{A} cos(ϕₛ+ϕ₀)] (8)

[Math. 9]

i₂=ηI₂=2ηI_{DC} (9)

Here, the average light intensity detected by the photodetector PD2 becomes two times I_{DC} (that is, 2I_{DC}). By optically or electrically adjusting the intensity and then inputting the adjusted intensity to the differential detection unit, the current Δi of the differential signal, which is the output signal of the differential detection unit, is expressed by the following equation.

$$[ Math . 10 ]$$

$$\begin{matrix}Δ i = η ( {I}_{1} - \frac{1}{2} {I}_{2} ) \\ = η {I}_{A} cos ( {ϕ}_{s} + {ϕ}_{0} )\end{matrix} \qquad ( 10 )$$

In FIG. 5, a mechanism for adjusting intensity of an input signal of the differential detector is not illustrated.

As can be seen from Equation (10), the current Δi of the differential signal does not include a term including the average light intensity I_{DC} in configuration example 2. Therefore, it is possible to measure the optical phase modulation amount cps by sound without being affected by noise included in the average light intensity.

### Configuration Example 3

FIG. 6 is a diagram illustrating an example of a configuration of the sound measurement apparatus. The sound measurement apparatus illustrated in FIG. 6 is a configuration example by an interferometer using a polarizing element, and includes an interferometer, a sound measurement unit (not illustrated), two photodetectors, and a differential detection unit. The interferometer includes two polarization beam splitters, two ½ wavelength plates, two ¼ wavelength plates, and two mirrors (not illustrated). In FIG. 6, PBS, H, and Q represent the polarization beam splitter, the ½ wavelength plate, and the ¼ wavelength plate, respectively.

Hereinafter, an operation of the sound measurement apparatus in FIG. 6 will be described. Here, it is assumed that the light emitted from the light source is linearly polarized light. The linearly polarized light emitted from the light source is converted into linearly polarized light inclined at 45° by a ½ wavelength plate (a ½ wavelength plate located at a position close to the light source). The converted linearly polarized light is branched into orthogonal linearly polarized light beams by the polarization beam splitter. The two linearly polarized light beams are transmitted through the ¼ wavelength plate twice, directions thereof are rotated by 90°, the light beams return to the polarization beam splitter again, and light is output from a port (a port from which light is emitted in a left direction in FIG. 6) different from a port on which the two linearly polarized light beams are incident. This light is a superposition of two linearly polarized light beams orthogonal to each other. Then, directions of the two linearly polarized light beams are rotated by 45° by the ½ wavelength plate. This is branched by another polarizing beam splitter and detected by two photodetectors PD1 and PD2. In this case, currents of the electrical signals output from the two photodetectors PD1 and PD2 are equal to the currents i₁ and i₂ in Equations (5) and (6) except for a constant term. Therefore, the current Δi of the differential signal, which is an output signal of the differential detector, is expressed by Equation (7).

### Modification Example

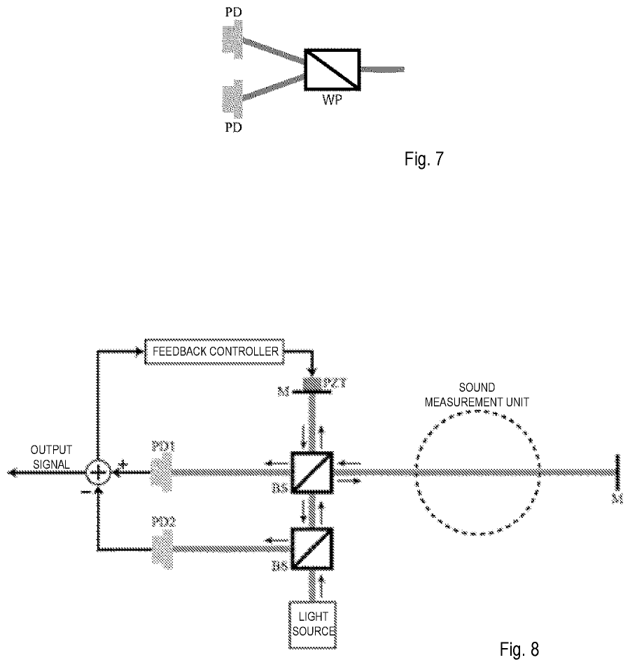

As illustrated in FIG. 7, the sound measurement apparatus can be configured by using a Wollaston prism (WP in FIG. 7). FIG. 7 illustrates a configuration example of a sound measurement apparatus in which the polarization beam splitter located near the photodetector illustrated in FIG. 6 is replaced with the Wollaston prism. Two linearly polarized light beams are separated in different directions from the same plane by the Wollaston prism. Therefore, it becomes possible to perform detection using two photodetectors disposed on the same plane without using an additional optical element by using the Wollaston prism.

### Configuration Example 4

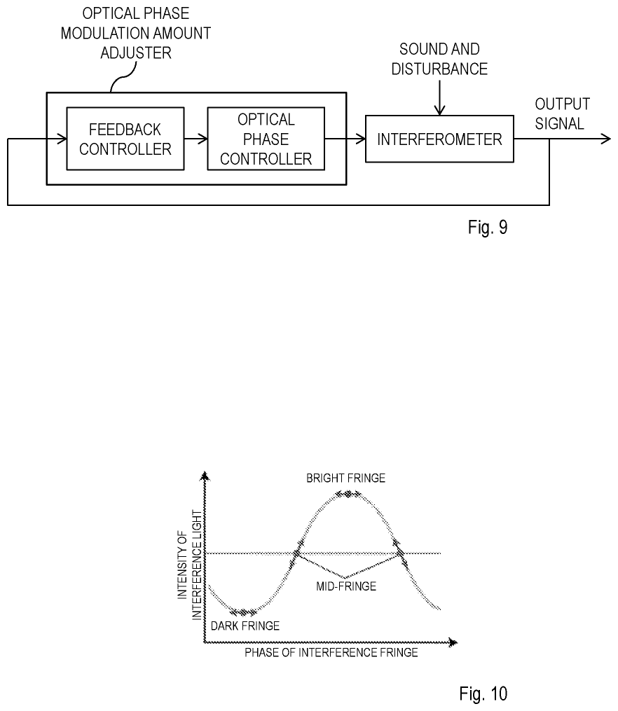

FIG. 8 is a diagram illustrating a configuration example of the sound measurement apparatus. The sound measurement apparatus in FIG. 8 includes an interferometer that performs feedback control using a differential signal that is an output signal, and differs from the sound measurement apparatus in FIG. 2 in that a feedback controller and a piezo element (PZT in FIG. 8) are further included for the feedback control. Here, a constituent unit including the feedback controller and the piezo element is called an optical phase modulation amount adjuster. Generally, the optical phase modulation amount adjuster includes a feedback controller and an optical phase controller, as illustrated in FIG. 9. The optical phase modulation amount adjuster fixes the interferometer so that a phase of the interference fringe is in mid-fringe by using a differential signal as an error signal to adjust an optical phase modulation amount φ₀ by an element other than sound. In the sound measurement apparatus in FIG. 8, the optical phase modulation amount φ₀ is adjusted by a piezo element serving as an optical phase controller controlling a position of the mirror in a reference optical path. Here, the reference optical path is an optical path in which light passes through the beam splitter, is reflected by the mirror, and passes through the beam splitter inside the interferometer. Further, an optical path in which light passes through the inside of the interferometer in order of the beam splitter and the sound measurement unit, is reflected by the mirror, and passes through the inside of the interferometer in order of the sound measurement unit and the beam splitter is called a measurement optical path. The adjustment of the optical phase modulation amount is performed in a frequency band lower than a frequency of sound that is a measurement target.

Hereinafter, an operation of the optical phase modulation amount adjuster will be described. First, a mid-fringe lock that is a principle of the operation will be described. FIG. 10 illustrates a relationship between the phase of the interference fringe and the intensity (light amount) of the interference light. As illustrated in FIG. 10, a point at which the intensity of the interference light is minimized and a point at which the intensity of the interference light is maximized are referred to as a dark fringe and a bright fringe, respectively. Further, an intermediate point between the dark fringe and the bright fringe is referred to as a mid-fringe. In the mid-fringe, a change in light intensity with respect to a phase change, that is, sensitivity of the interferometer is maximized. Therefore, the sensitivity of the interferometer can be maximized by fixing the interferometer so that the phase of the interference fringe is always in mid-fringe when there is no sound that is a measurement target. A method of controlling the interferometer in this way is called mid-fringe lock. That is, the optical phase modulation amount adjuster is a constituent unit that performs mid-fringe lock on the interferometer.

Here, two optical phase modulation amounts φₛ and φ₀ included in the light amount of the interference light I=I_{DC}+I_{A} cos (φₛ+φ₀) is considered. A variation amount and frequency of the optical phase modulation amount φₛ by sound depends on sound that is a measurement target. On the other hand, the optical phase modulation amount φ₀ by an element other than sound includes a stationary term determined by disposition of an optical system, and a gradual variation caused by air variation, ground vibration, or the like. As can be seen from FIG. 11, the optical phase modulation amount φ₀ has a larger power at a lower frequency component, and is mainly dominated by a component at 100 Hz or less. Therefore, by performing feedback control in a frequency band lower than a frequency of the sound that is a measurement target, it is possible to realize a variation amount of the optical phase modulation amount φ₀ of zero (that is, fix the optical phase modulation amount φ₀ to a certain constant) and leave a variation of the optical phase modulation amount φₛ as it is.

The phase of the interference fringe is in the mid-fringe, the optical phase modulation amount φ₀ can be expressed as φ₀=Π/2+NΠ (where N is an integer). Therefore, for example, when mid-fringe lock is performed so that φ₀=−Π/2, the amount of interference light is I=I_{DC}+I_{A} sin(φₛ). In this case, the current Δi of the differential signal, which is the output signal of the differential detection unit, is expressed by the following equation.

[Math. 11]

Δi=2ηI_{A} sin(ϕₛ) (11)

Here, because φₛ<<1 holds for general sound, the current Δi of the differential signal can be approximated by the following equation.

[Math. 12]

Δi=2ηI_{A}ϕₛ (12)

Therefore, when mid-fringe lock is achieved in a frequency band lower than that of sound that is a measurement target, the current Δi of the differential signal and the optical phase modulation amount φₛ by sound are in a proportional relationship, and the differential signal itself becomes a low-noise sound signal.

In general, when mid-fringe lock is performed so that φ₀=Π/2+NΠ, a sign of the current Δi may be inverted depending on a value of N, but in this case, a sign of the differential signal may be simply inverted.

Hereinafter, an operation of the optical phase modulation amount adjuster for achieving mid-fringe lock will be described (see FIG. 9). First, the differential signal is input to the feedback controller as an error signal. The feedback controller generates a control signal to cancel out the variation of the optical phase modulation amount φ₀ by an element other than sound with respect to this error signal (to realize a variation amount of the optical phase modulation amount φ₀ by an element other than sound of zero). This can be realized by making a control band lower than the frequency of the sound as described above. Further, for the feedback controller, for example, it is possible to use any system that serves to generate a drive signal of the optical phase controller so that the error signal of zero is realized in a band including no sound, such as an electric circuit including a single or a plurality of amplifiers and integrators, a PID controller, or a digital circuit. Next, the optical phase controller is driven by using a control signal that is an output signal of the feedback controller. The optical phase controller controls a position of the mirror on the reference optical path or the mirror on the measurement optical path, or controls a phase of light (reference light) propagating through the reference optical path or light (measurement light) propagating through the measurement optical path using an optical phase modulator inserted into the reference optical path or the measurement optical path. In a method for controlling a position of a mirror, for example, a piezo element attached to the mirror is driven by a control signal and the reference optical path or the measurement optical path is extended or contracted so that a phase difference between two light beams is controlled and the interference fringe is fixed to the mid-fringe (see FIG. 8). On the other hand, in a method for controlling a phase of the reference light or the measurement light, the optical phase modulator inserted into the reference optical path or the measurement optical path is driven by a control signal and the phase of the reference light or the measurement light is controlled so that the phase difference between the two light beams is controlled and the interference fringe is fixed to the mid-fringe. In operation, because sound that is a measurement target and a factor (disturbance) other than the sound are input to the interferometer, the feedback control is continued so that only the disturbance is canceled out (the variation amount of the optical phase modulation amount φ₀ of zero is realized). Thus, only the optical phase modulation amount φₛ by sound is outputted from the interferometer. Therefore, a low noise differential signal proportional to the optical phase modulation amount φₛ can be obtained.

As described above, it is possible to realize mid-fringe lock by performing feedback control using the differential signal as an error signal. It becomes possible to measure the sound at a maximum sensitivity point near the mid-fringe by setting the control band lower than the frequency of the sound that is a measurement target. Further, when an amplitude of the sound that is a measurement target is small, the optical phase modulation amount φₛ and the current Δi of the differential signal are in a proportional relationship, and the differential signal can be extracted as a low-noise sound signal without post-processing.

### Configuration Example 5

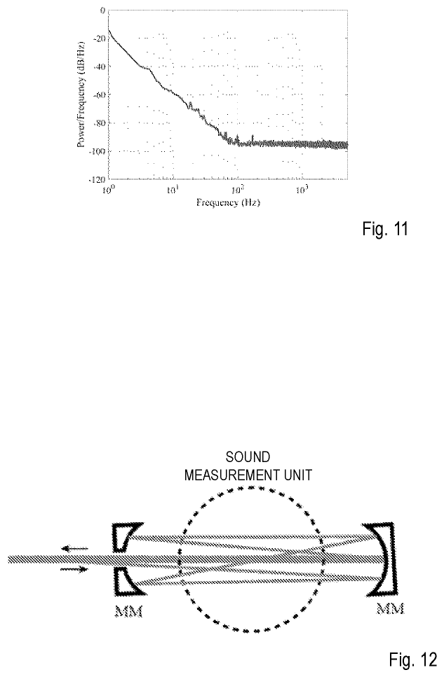

FIG. 12 is a diagram illustrating an example of a configuration for measuring the optical phase change amount by sound with high sensitivity by multiplexing the optical paths of the sound measurement unit in Configuration examples 1 to 4 of the sound measurement apparatus. In the configuration illustrated in FIG. 12, a multi-path mirror is disposed so that light passes through the sound measurement unit a plurality of times. This increases the optical phase change amount Ys by sound. Specifically, when the number of times of reciprocation of light is M, the optical phase change amount Ys by sound becomes M times.

### First Embodiment

The sound measurement apparatus 100 receives light emitted from a light source as an input, and measures an optical phase modulation amount φₛ by sound.

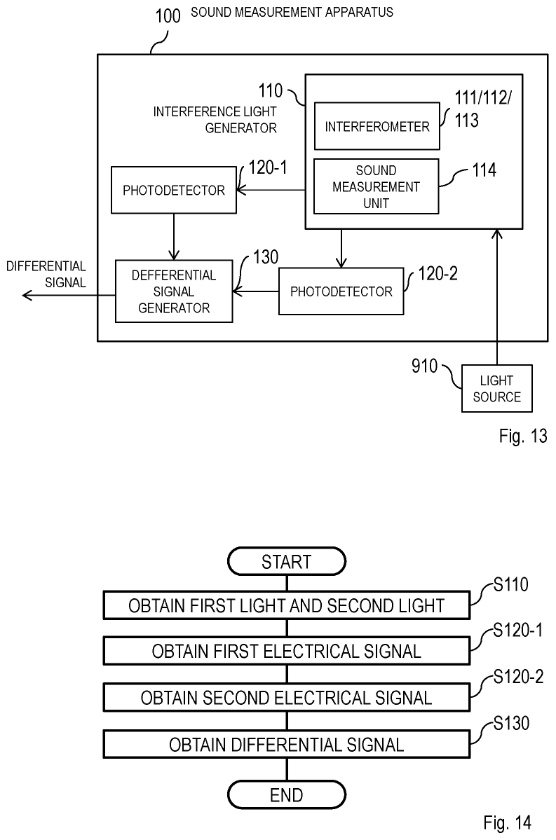

Hereinafter, the sound measurement apparatus 100 will be described with reference to FIGS. 13 and 14. FIG. 13 is a block diagram illustrating a configuration of the sound measurement apparatus 100. FIG. 14 is a flowchart illustrating an operation of the sound measurement apparatus 100. As illustrated in FIG. 13, the sound measurement apparatus 100 includes an interference light generator 110, two photodetectors 120 (hereinafter referred to as a first photodetector 120-1 and a second photodetector 120-2), and a differential signal generator 130. Further, the interference light generator 110 includes an interferometer 111/112/113, and a sound measurement unit 114 that modulates a phase of the light using the sound.

An operation of the sound measurement apparatus 100 will be described with reference to FIG. 14.

In S110, the interference light generator 110 receives light emitted from a light source 910 as an input, obtains, from the light emitted from the light source, light (hereinafter referred to as first light) including light subjected to light phase modulation by the sound measurement unit 114 and light (hereinafter referred to as second light) including light subjected to light phase modulation by the sound measurement unit 114, which differs from the first light, and outputs the light. A phase of the light subjected to optical phase modulation included in the first light and a phase of the light subjected to optical phase modulation included in the second light have an inverted relationship.

In S120-1, the first photodetector 120-1 receives the first light output in S110 as an input, obtains an electrical signal (hereinafter referred to as a first electrical signal) from the first light, and outputs the electrical signal.

In S120-2, the second photodetector 120-2 receives the second light output in S110 as an input, obtains an electrical signal (hereinafter referred to as a second electrical signal) from the second light, and outputs the electrical signal.

The sound measurement apparatus 100 may include a first light amount adjuster (not illustrated) that adjusts an amount of the first light and a second light amount adjuster (not illustrated) that adjusts an amount of the second light so that amplitudes of the first electrical signal and the second electrical signal are the same.

In S130, the differential signal generator 130 receives the first electrical signal output in S120-1 and the second electrical signal output in S120-2 as inputs, obtains a differential signal as a difference between the first electrical signal and the second electrical signal, and outputs the differential signal.

The optical phase modulation amount Ys by sound is measured as the current Δi of the differential signal expressed by an equation Δi=βI_{A} cos (φₛ+φ₀) (where β is a predetermined constant, I_{A} is an amplitude of the interference fringe, and φ₀ is an optical phase modulation amount by an element other than sound).

Hereinafter, a configuration example of the interference light generator 110 will be described.

### Configuration Example 1

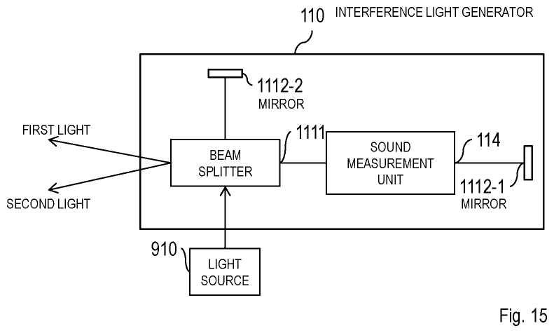

As illustrated in FIG. 15, the interference light generator 110 includes an interferometer 111 (not illustrated) and a sound measurement unit 114. The interferometer 111 includes a beam splitter 1111, and two mirrors 1112 (hereinafter a first mirror 1112-1 and a second mirror 1112-2). The sound measurement apparatus 100 including the interferometer 111 corresponds to (Configuration example 1) described in <Technical background>. As illustrated in FIG. 2, the sound measurement apparatus 100 may include a beam splitter (not illustrated) near the second photodetector 120-2.

When the light propagating through the first optical path in the interference light generator 110 is light that passes through the beam splitter 1111 and the sound measurement unit 114 in this order, is reflected by the first mirror 1112-1, and passes through the sound measurement unit 114 and the beam splitter 1111 in this order, and the light propagating through the second optical path in the interference light generator 110 is light that passes through the beam splitter 1111, is reflected by the second mirror 1112-2, and passes through the beam splitter 1111, the first light and the second light is light that is obtained by branching the light propagating through the first optical path in the interference light generator 110 and the light propagating through the second optical path in the interference light generator 110 in the beam splitter 1111.

### Configuration Example 2

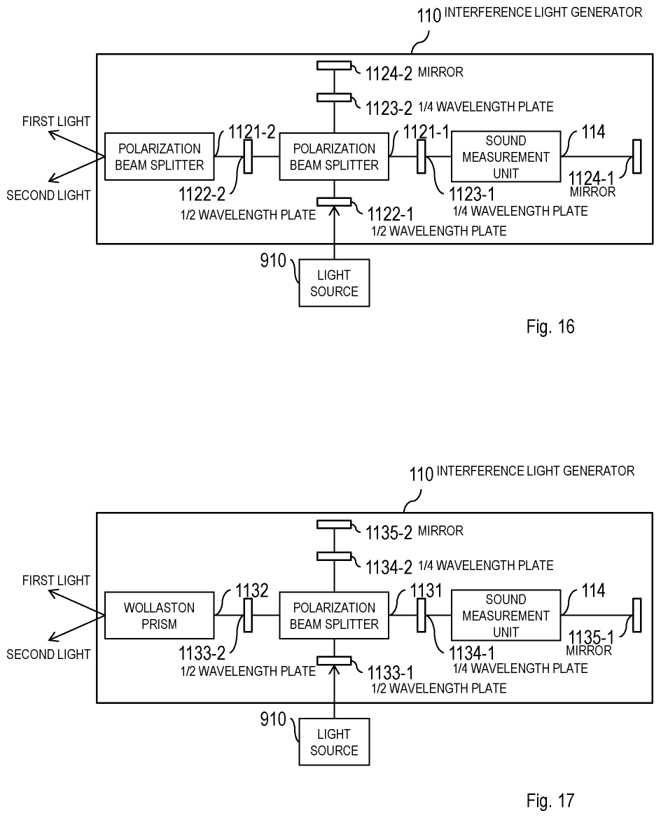

As illustrated in FIG. 16, the interference light generator 110 includes an interferometer 112 (not illustrated) and a sound measurement unit 114. The interferometer 112 includes two polarization beam splitters 1121 (hereinafter referred to as a first polarization beam splitter 1121-1 and a second polarization beam splitter 1121-2), two ½ wavelength plates 1122 (hereinafter referred to as a first ½ wavelength plate 1122-1 and a second ½ wavelength plate 1122-2), two ¼ wavelength plates 1123 (hereinafter referred to as a first ¼ wavelength plate 1123-1 and a second ¼ wavelength plate 1123-2), and two mirrors 1124 (hereinafter referred to as a first mirror 1124-1 and a second mirror 1124-2). The sound measurement apparatus 100 including the interferometer 112 corresponds to (Configuration example 3) described in <Technical background>.

When the light propagating through the first optical path in the interference light generator 110 is light that passes through the first ½ wavelength plate 1122-1, the first polarization beam splitter 1121-1, the first ¼ wavelength plate 1123-1, and the sound measurement unit 114 in this order, is reflected by the first mirror 1124-1, and passes through the sound measurement unit 114, the first ¼ wavelength plate 1123-1, the first polarization beam splitter 1121-1, the second ½ wavelength plate 1122-2, and the second polarization beam splitter 1121-2 in this order, and the light propagating through the second optical path in the interference light generator 110 is light that passes through the first ½ wavelength plate 1122-1, the first polarization beam splitter 1121-1, and the second ¼ wavelength plate 1123-2 in this order, is reflected by the second mirror 1124-2, and passes through the second ¼ wavelength plate 1123-2, the first polarization beam splitter 1121-1, the second ½ wavelength plate 1122-2, and the second polarization beam splitter 1121-2 in this order, the first light and the second light are light that is obtained by branching the light propagating through the first optical path in the interference light generator 110 and the light propagating through the second optical path in the interference light generator 110 in the second polarization beam splitter 1121-2.

Although a positional relationship between the first ¼ wavelength plate 1123-1 and the sound measurement unit 114 is a positional relationship in which the first ¼ wavelength plate 1123-1 is to the left and the sound measurement unit 114 is to the right in FIG. 16, the positional relationship may be reversed. In this case, the light propagating in the first optical path in the interference light generator 110 is light that passes through the first ½ wavelength plate 1122-1, the first polarization beam splitter 1121-1, the sound measurement unit 114, and the first ¼ wavelength plate 1123-1 in this order, is reflected by the first mirror 1124-1, and passes through the first ¼ wavelength plate 1123-1, the sound measurement unit 114, the first polarization beam splitter 1121-1, the second ½ wavelength plate 1122-2, and the second polarization beam splitter 1121-2 in this order.

### Configuration Example 3

As illustrated in FIG. 17, the interference light generator 110 includes an interferometer 113 (not illustrated) and a sound measurement unit 114. The interferometer 113 includes a polarization beam splitter 1131, a Wollaston prism 1132, two ½ wavelength plates 1133 (hereinafter, a first ½ wavelength plate 1133-1 and a second ½ wavelength plate 1133-2), two ¼ wavelength plates 1134 (hereinafter referred to as a first ¼ wavelength plate 1134-1 and a second ¼ wavelength plate 1134-2), and two mirrors 1135 (hereinafter referred to as a first mirror 1135-1 and a second mirror 1135-2). The sound measurement apparatus 100 including the interferometer 113 corresponds to (Modification example) of (Configuration example 3) described in <Technical background>.

When the light propagating through the first optical path in the interference light generator 110 is light that passes through the first ½ wavelength plate 1133-1, the polarization beam splitter 1131, the first ¼ wavelength plate 1134-1, and the sound measurement unit 114 in this order, is reflected by the first mirror 1135-1, and passes through the sound measurement unit 114, the first ¼ wavelength plate 1134-1, the polarization beam splitter 1131, the second ½ wavelength plate 1133-2, and the Wollaston prism 1132 in this order, and the light propagating through the second optical path in the interference light generator 110 is light that passes through the first ½ wavelength plate 1133-1, the polarization beam splitter 1131, and the second ¼ wavelength plate 1134-2 in this order, is reflected by the second mirror 1135-2, and passes through the second ¼ wavelength plate 1134-2, the polarization beam splitter 1131, the second ½ wavelength plate 1133-2, and the Wollaston prism 1132 in this order, the first light and the second light are light obtained by branching the light propagating in the first optical path in the interference light generator 110 and the light propagating in the second optical path in the interference light generator 110 in the Wollaston prism 1132.

Although a positional relationship between the first ¼ wavelength plate 1134-1 and the sound measurement unit 114 is a positional relationship in which the first ¼ wavelength plate 1134-1 is to the left and the sound measurement unit 114 is to the right in FIG. 17, the positional relationship may be reversed. In this case, the light propagating in the first optical path in the interference light generator 110 is light that passes through the first ½ wavelength plate 1133-1, the polarization beam splitter 1131, the sound measurement unit 114, and the first ¼ wavelength plate 1134-1 in this order, is reflected by the first mirror 1135-1, and passes through the first ¼ wavelength plate 1134-1, the sound measurement unit 114, the polarization beam splitter 1131, the second ½ wavelength plate 1133-2, and the Wollaston prism 1132 in this order.

According to the embodiment of the present invention, it is possible to measure the optical phase modulation amount by sound without being affected by noise included in an average light intensity.

### Second Embodiment

The sound measurement apparatus 200 receives light emitted from the light source as an input and measures an optical phase modulation amount φₛ by sound.

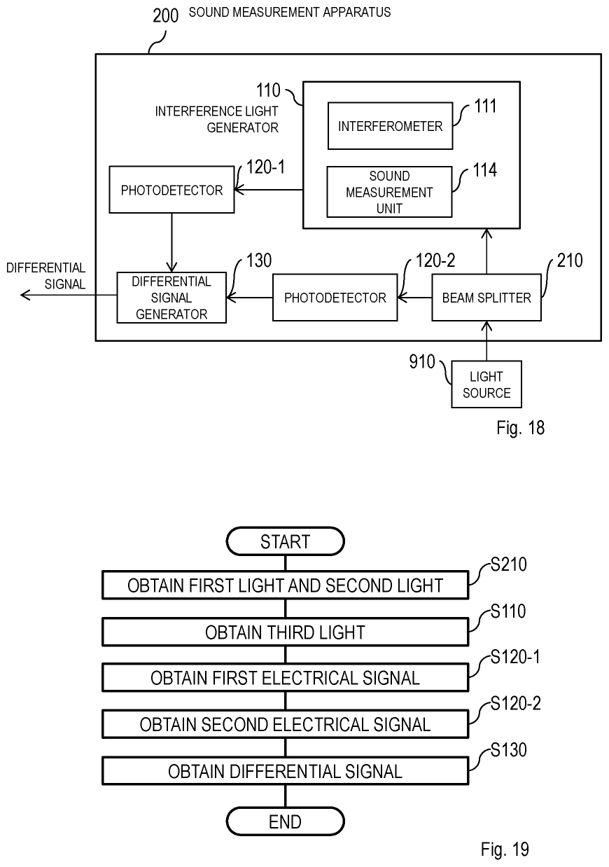

Hereinafter, the sound measurement apparatus 200 will be described with reference to FIGS. 18 and 19. FIG. 18 is a block diagram illustrating a configuration of the sound measurement apparatus 200.

FIG. 19 is a flowchart illustrating an example of an operation of the sound measurement apparatus 200. As illustrated in FIG. 18, the sound measurement apparatus 200 includes a beam splitter 210, an interference light generator 110, two photodetectors 120 (hereinafter referred to as a first photodetector 120-1 and a second photodetector 120-2), and a differential signal generator 130. Further, the interference light generator 110 includes an interferometer 111, and a sound measurement unit 114 that modulates a phase of light using sound.

An operation of the sound measurement apparatus 200 will be described with reference to FIG. 19.

In S210, the beam splitter 210 receives the light emitted from the light source 910 as an input, and branches the light emitted from the light source to thereby obtain and output two light beams (hereinafter referred to as first light and second light).

In S110, the interference light generator 110 receives the first light output in S210 as an input, obtains light including light subjected to light phase modulation by the sound measurement unit 114 (hereinafter referred to as third light) from the first light, and outputs the light.

In S120-1, the first photodetector 120-1 receives the third light output in S110 as an input, obtains an electrical signal (hereinafter referred to as a first electrical signal) from the third light, and outputs the electrical signal.

In S120-2, the second photodetector 120-2 receives the second light output in S210 as an input, obtains an electrical signal (hereinafter referred to as a second electrical signal) from the second light, and outputs the electrical signal.

The sound measurement apparatus 200 includes any one of a light amount adjuster (not illustrated) that adjusts an amount of the second light, and a current adjuster (not illustrated) that adjusts a current of the second electrical signal so that amplitudes of the first electrical signal and the second electrical signal are the same.

In S130, the differential signal generator 130 receives the first electrical signal output in S120-1 and the second electrical signal output in S120-2 as inputs, obtains a differential signal as a difference between the first electrical signal and the second electrical signal, and outputs the differential signal.

The optical phase modulation amount φₛ by sound is measured as the current Δi of the differential signal expressed by an equation Δi=βI_{A} cos (φₛ+φ₀) (where β is a predetermined constant, I_{A} is an amplitude of the interference fringe, and φ₀ is an optical phase modulation amount by an element other than sound).

A configuration of the interference light generator 110 may be the same as that in (Configuration example 1) of the interference light generator 110 described in the first embodiment. Therefore, the third light is light that is obtained by branching light propagating through the first optical path in the interference light generator 110 and the light propagating through the second optical path in the interference light generator 110 in the beam splitter 1111.

According to the embodiment of the present invention, it is possible to measure the optical phase modulation amount by sound without being affected by noise included in an average light intensity.

### Third Embodiment

The sound measurement apparatus 300 receives light emitted from the light source as an input, and measures the optical phase modulation amount φₛ by sound.

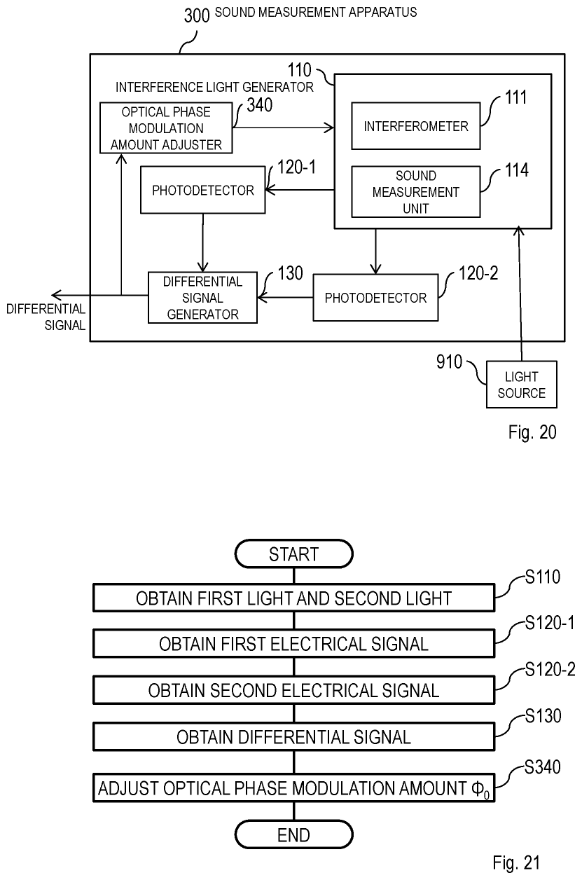

Hereinafter, the sound measurement apparatus 300 will be described with reference to FIGS. 20 and 21. FIG. 20 is a block diagram illustrating a configuration of the sound measurement apparatus 300. FIG. 21 is a flowchart illustrating an example of an operation of the sound measurement apparatus 300. As illustrated in FIG. 20, the sound measurement apparatus 300 includes an interference light generator 110, two photodetectors 120 (hereinafter referred to as a first photodetector 120-1 and a second photodetector 120-2), a differential signal generator 130, and an optical phase modulation amount adjuster 340. Further, the interference light generator 110 includes an interferometer 111 and a sound measurement unit 114 that modulates a phase of light using sound.

An operation of the sound measurement apparatus 300 will be described with reference to FIG. 21.

In S110, the interference light generator 110 receives light emitted from a light source 910 as an input, obtains, from the light emitted from the light source, light (hereinafter referred to as first light) including light subjected to light phase modulation by the sound measurement unit 114 and light (hereinafter referred to as second light) including light subjected to light phase modulation by the sound measurement unit 114, which differs from the first light, and outputs the light. A phase of the light subjected to optical phase modulation included in the first light and a phase of the light subjected to optical phase modulation included in the second light have an inverted relationship.

In S120-1, the first photodetector 120-1 receives the first light output in S110 as an input, obtains an electrical signal (hereinafter referred to as a first electrical signal) from the first light, and outputs the electrical signal.

In S120-2, the second photodetector 120-2 receives the second light output in S110 as an input, obtains an electrical signal (hereinafter referred to as a second electrical signal) from the second light, and outputs the electrical signal.

The sound measurement apparatus 300 may include a first light amount adjuster (not illustrated) that adjusts an amount of the first light and a second light amount adjuster (not illustrated) that adjusts an amount of the second light so that amplitudes of the first electrical signal and the second electrical signal are the same.

In S130, the differential signal generator 130 receives the first electrical signal output in S120-1 and the second electrical signal output in S120-2 as inputs, obtains a differential signal as a difference between the first electrical signal and the second electrical signal, and outputs the differential signal.

In S340, the optical phase modulation amount adjuster 340 receives the differential signal output in S130 as an input and fixes the interferometer 111 so that the phase of the interference fringe is in mid-fringe using the differential signal as an error signal, to adjust the optical phase modulation amount φ₀ by an element other than sound.

The optical phase modulation amount φₛ by sound is measured as a current Δi of the differential signal expressed by an equation Δi=βI_{A} sin (φₛ) (where B is a predetermined constant, and I_{A} is an amplitude of an interference fringe). When φₛ<<1 is established, the optical phase modulation amount φₛ by sound is measured as the current Δi of the differential signal expressed by an equation Δi=βI_{A}φₛ (where β is a predetermined constant and I_{A} is an amplitude of the interference fringe).

A configuration of the interference light generator 110 may be the same as (Configuration example 1) of the interference light generator 110 described in the first embodiment. In this case, the optical phase modulation amount adjuster 340 uses the differential signal to generate a control signal for control so that a value of the variation amount of the optical phase modulation amount φ₀ by an element other than sound of zero is realized (that is, the optical phase modulation amount φ₀ by an element other than sound becomes a certain constant) in a frequency band lower than a frequency of the sound that is a measurement target, and uses the control signal to control a phase difference between the light propagating through the first optical path in the interference light generator 110 and the light propagating in the second optical path in the interference light generator 110, thereby adjusting the optical phase modulation amount φ₀ by an element other than sound and fixing the interferometer 111 so that the phase of the interference fringe is in the mid-fringe.

Here, the optical phase modulation amount adjuster 340 may drive a piezo element attached to the first mirror 1112-1 using a control signal to expand and contract the first optical path in the interference light generator 110, so that the phase difference between the light propagating through the first optical path in the interference light generator 110 and the light propagating in the second optical path in the interference light generator 110 is controlled, and the optical phase modulation amount adjuster 340 may drive a piezo element attached to the second mirror 1112-2 using a control signal to expand and contract the second optical path in the interference light generator 110, so that the phase difference between the light propagating through the first optical path in the interference light generator 110 and the light propagating in the second optical path in the interference light generator 110 is controlled. Further, the optical phase modulation amount adjuster 340 may drive an optical phase modulator inserted between the beam splitter 1111 and the first mirror 1112-1 of the first optical path in the interference light generator 110 using a control signal and control the phase of the light propagating in the first optical path in the interference light generator 110, so that the phase difference between the light propagating through the first optical path in the interference light generator 110 and the light propagating in the second optical path in the interference light generator 110 is controlled, and the optical phase modulation amount adjuster 340 may drive an optical phase modulator inserted between the beam splitter 1111 and the second mirror 1112-2 of the second optical path in the interference light generator 110 using a control signal and control the phase of the light propagating in the second optical path in the interference light generator 110, so that the phase difference between the light propagating through the first optical path in the interference light generator 110 and the light propagating in the second optical path in the interference light generator 110 is controlled.

According to the embodiment of the present invention, it is possible to measure the optical phase modulation amount by sound without being affected by noise included in an average light intensity.

### Fourth Embodiment

The interference light generator 110 included in the sound measurement apparatus 100/200/300 may include a multi-path mirror, as in (Configuration example 5) described in <Technical background>.

Therefore, the interference light generator 110 further includes a multi-path mirror, and the light propagating through the first optical path in the interference light generator 110 becomes light of which the optical phase modulation amount Ds by sound has been increased due to reflection in the multi-path mirror.

According to the embodiment of the present invention, it is possible to measure the optical phase modulation amount by sound without being affected by noise included in an average light intensity.

### <Supplements>

The above description of the embodiment of the present invention is presented for the purpose of illustration and description. The description is not intended to be comprehensive and to limit the present invention to disclosed strict forms. Modifications or variations can be made from the teachings described above. The embodiments have been selected and represented to provide the best illustration of the principle of the present invention and to allow those skilled in the art to use the present invention in various embodiments and in various added modifications suitable for thoroughly considered practical uses. All of such modifications or variations are within the scope of the present invention defined by the appended claims interpreted with a fairly, legally, and equitably given range.

1. A sound measurement method for measuring an optical phase modulation amount φₛ by sound by a sound measurement apparatus including an interference light generator including an interferometer and a sound measurement unit configured to modulate a phase of light using sound, two photodetectors (hereinafter referred to as a first photodetector and a second photodetector), and a differential signal generator, the sound measurement method comprising:
an interference light generation step of obtaining, by the interference light generator, from light emitted from a light source, light (hereinafter referred to as first light) including light subjected to light phase modulation by the sound measurement unit and light (hereinafter referred to as second light) including light subjected to light phase modulation by the sound measurement unit, the second light differing from the first light;
a first light detection step of obtaining, by the first photodetector, an electrical signal (hereinafter referred to as a first electrical signal) from the first light;
a second light detection step of obtaining, by the second photodetector, an electrical signal (hereinafter referred to as a second electrical signal) from the second light; and
a differential signal generation step of obtaining, by the differential signal generator, a differential signal from the first electrical signal and the second electrical signal, the differential signal being a difference between the first electrical signal and the second electrical signal,
wherein
a phase of the light subjected to the light phase modulation included in the first light and a phase of the light subjected to the light phase modulation included in the second light are in an inverted relationship, and
the optical phase modulation amount φₛ is measured as a current Δi of the differential signal expressed by an equation Δi=βI_{A} cos (φₛ+φ₀) (where β is a predetermined constant, I_{A} is an amplitude of an interference fringe, and φ₀ is an optical phase modulation amount by an element other than sound).

2. The sound measurement method according to claim 1,
wherein the interferometer includes a beam splitter, and two mirrors (hereinafter referred to as a first mirror and a second mirror), light propagating through a first optical path in the interference light generator is light passing through the beam splitter and the sound measurement unit in this order, reflected by the first mirror, and passing through the sound measurement unit and the beam splitter in this order,
light propagating through a second optical path in the interference light generator is light passing through the beam splitter, reflected by the second mirror, and passing through the beam splitter, and
the first light and the second light are light obtained by branching light propagating through a first optical path in the interference light generator and light propagating through a second optical path in the interference light generator in the beam splitter.

3. The sound measurement method according to claim 1,
wherein the interferometer includes two polarization beam splitters (hereinafter referred to as a first polarization beam splitter and a second polarization beam splitter), two ½ wavelength plates (hereinafter referred to as a first ½ wavelength plate and a second ½ wavelength plate), two ¼ wavelength plates (hereinafter referred to as a first ¼ wavelength plate and a second ¼ wavelength plate), and two mirrors (hereinafter referred to as first mirror and a second mirror),
light propagating through a first optical path in the interference light generator is light passing through the first ½ wavelength plate, the first polarization beam splitter, the first ¼ wavelength plate, and the sound measurement unit in this order, reflected by the first mirror, and passing through the sound measurement unit, the first ¼ wavelength plate, the first polarization beam splitter, the second ½ wavelength plate, and the second polarization beam splitter in this order,
light propagating in a second optical path in the interference light generator is light passing through the first ½ wavelength plate, the first polarization beam splitter, and the second ¼ wavelength plate in this order, reflected by the second mirror, and passing through the second ¼ wavelength plate, the first polarization beam splitter, the second ½ wavelength plate, and the second polarization beam splitter in this order, and
the first light and the second light are light obtained by branching light propagating through a first optical path in the interference light generator and light propagating through a second optical path in the interference light generator in the second polarization beam splitter.

4. The sound measurement method according to claim 1,
wherein the interferometer includes a polarization beam splitter, a Wollaston prism, two ½ wavelength plates (hereinafter referred to as a first ½ wavelength plate and a second ½ wavelength plate), two ¼ wavelength plates (hereinafter referred to as a first ¼ wavelength plate and a second ¼ wavelength plate), and two mirrors (hereinafter referred to as a first mirror and a second mirror), light propagating through a first optical path in the interference
light generator is light passing through the first ½ wavelength plate, the polarization beam splitter, the first ¼ wavelength plate, and the sound measurement unit in this order, reflected by the first mirror, and passing through the sound measurement unit, the first ¼ wavelength plate, the polarization beam splitter, the second ½ wavelength plate, and the Wollaston prism in this order,
light propagating in a second optical path in the interference light generator is light passing through the first ½ wavelength plate, the polarization beam splitter, and the second ¼ wavelength plate in this order, reflected by the second mirror, and passing through the second ¼ wavelength plate, the polarization beam splitter, the second ½ wavelength plate, and the Wollaston prism in the order, and the first light and the second light are light obtained by branching light propagating through a first optical path in the interference light generator and light propagating through a second optical path in the interference light generator in the Wollaston prism.

5. A sound measurement method for measuring an optical phase modulation amount φₛ by sound by a sound measurement apparatus including a beam splitter, an interference light generator including an interferometer and a sound measurement unit configured to modulate a phase of light using sound, two photodetectors (hereinafter referred to as a first photodetector and a second photodetector), and a differential signal generator, the sound measurement method comprising:
a light branching step of obtaining, by the beam splitter, two light beams (hereinafter referred to as first light and second light) from light emitted from a light source;
an interference light generation step of obtaining, by the interference light generator, light including light subjected to light phase modulation by the sound measurement unit (hereinafter referred to as third light) from the first light;
a first light detection step of obtaining, by the first photodetector, an electrical signal (hereinafter referred to as a first electrical signal) from the third light;
a second light detection step of obtaining, by the second photodetector, an electrical signal (hereinafter referred to as a second electrical signal) from the second light; and
a differential signal generation step of obtaining, by the differential signal generator, a differential signal from the first electrical signal and the second electrical signal, the differential signal being a difference between the first electrical signal and the second electrical signal,
wherein
the optical phase modulation amount φₛ is measured as a current Δi of the differential signal expressed by an equation Δi=βI_{A} cos (φₛ+φ₀) (where β is a predetermined constant, I_{A} is an amplitude of an interference fringe, and φ₀ is an optical phase modulation amount by an element other than sound).

6. The sound measurement method according to claim 5,
wherein the interferometer includes a beam splitter, and two mirrors (hereinafter referred to as a first mirror and a second mirror), light propagating through a first optical path in the interference light generator is light passing through the beam splitter and the sound measurement unit in this order, reflected by the first mirror, and passing through the sound measurement unit and the beam splitter in this order,
light propagating through a second optical path in the interference light generator is light passing through the beam splitter, reflected by the second mirror, and passing through the beam splitter, and
the third light is light obtained by branching light propagating through a first optical path in the interference light generator and light propagating through a second optical path in the interference light generator in the beam splitter.

7. A sound measurement method for measuring an optical phase modulation amount Ys by sound by a sound measurement apparatus including an interference light generator including an interferometer and a sound measurement unit configured to modulate a phase of light using sound, two photodetectors (hereinafter referred to as a first photodetector and a second photodetector), a differential signal generator, and an optical phase modulation amount adjuster, the sound measurement method comprising:
an interference light generation step of obtaining, by the interference light generator, from light emitted from a light source, light (hereinafter referred to as first light) including light subjected to light phase modulation by the sound measurement unit and light (hereinafter referred to as second light) including light subjected to light phase modulation by the sound measurement unit, the second light differing from the first light;
a first light detection step of obtaining, by the first photodetector, an electrical signal (hereinafter referred to as a first electrical signal) from the first light;
a second light detection step of obtaining, by the second photodetector, an electrical signal (hereinafter referred to as a second electrical signal) from the second light;
a differential signal generation step of obtaining, by the differential signal generator, a differential signal from the first electrical signal and the second electrical signal, the differential signal being a difference between the first electrical signal and the second electrical signal; and
an optical phase modulation amount adjustment step of adjusting, by the optical phase modulation amount adjuster, an optical phase modulation amount φ₀ by an element other than sound by fixing the interferometer so that a phase of an interference fringe is in mid-fringe by using the differential signal as an error signal,
wherein
a phase of the light subjected to the light phase modulation included in the first light and a phase of the light subjected to the light phase modulation included in the second light are in an inverted relationship, and
the optical phase modulation amount φₛ is measured as a current Δi of the differential signal expressed by an equation Δi=βI_{A} sin (φₛ) (where β is a predetermined constant, and I_{A} is an amplitude of an interference fringe).

8. The sound measurement method according to claim 7,
wherein the interferometer includes a beam splitter, and two mirrors (hereinafter referred to as a first mirror and a second mirror), light propagating through a first optical path in the interference light generator is light passing through the beam splitter and the sound measurement unit in this order, reflected by the first mirror, and passing through the sound measurement unit and the beam splitter in this order,
light propagating through a second optical path in the interference light generator is light passing through the beam splitter, reflected by the second mirror, and passing through the beam splitter, and the first light and the second light are light obtained by branching light propagating through a first optical path in the interference light generator and light propagating through a second optical path in the interference light generator in the beam splitter.
